(19) United States
(12) Patent Application Publication
(10) Pub. No.: US 2007/0265779 A1
(43) Pub. Date: Nov. 15, 2007

(54) Estimating development of new user interface

(76) Inventor: Filip Misovski, Frankfurt (DE)

Correspondence Address: SCHWEGMAN, LUNDBERG & WOESSNER/SAP, P.O. BOX 2938, MINNEAPOLIS, MN, 55402, US

(21) Appl. No.: 11/434,323

(22) Filed: May 15, 2006

(51) Int. Cl. G06F 19/00

(52) U.S. Cl. 702/1; 702/127

(57) ABSTRACT

A method of estimating a size of developing a user interface for a predefined application development includes receiving a request for an estimated size of developing the UI. The method includes reading, in response to the request, weight points for the UI from a UI taxonomy that is an abstraction of a class of UIs. The UI is to be an instance of the class. The method includes generating the estimated size using at least the weight points. A computer system includes a UI taxonomy that is an abstraction of a class of UIs, wherein the system has received a request for an estimated size of developing a UI that is to be an instance of the class. The system further includes a size estimating module that generates the estimated size using weight points for the UI read from the UI taxonomy.

### TECHNICAL FIELD

The description relates to estimating a size of developing a user interface.

### BACKGROUND

A big planning challenge for companies with development release cycles is the adoption of user interface (UI) concepts based on new underlying technology. As an example regarding SAP AG, the technologies WebDynpro, Enterprise Services Architecture (ESA) and Service-Oriented Architecture (SOA) can be mentioned. Today, product managers or project leaders may not be able to sufficiently estimate UI development (or migration) efforts for any of these technologies-before adopting a new UI technology. Moreover, the experience from previous developments with older UI technology may not provide sufficient guidance to do the estimation if the underlying changes in the new and more complex UI technology layer dictate different time/resource requirements.

Additionally, applications continue to grow in size and complexity. In the new era of composite applications, the dependency of UI developments is very high. Future composite applications may depend on several other UI developments. As applications and requirements grow, support tools to understand and communicate size need to be used.

This core problem of estimating UI development is applicable to many companies and enterprises who will engage in UI developments in-house or rely on off-shore models. Development contracts between the project and implementation organizations may require accurate estimates that are to serve as a key ingredient in assuring scope and prioritization of UI developments.

Function point analysis (FPA) is one of the major estimation methods used with UI centric applications over the last two decades. This method is improved meanwhile for both transactional and no-transactional type of applications. Most professional offshore companies address a request for proposal with FPA estimation. FPA is a process of counting functional points in application development. It is a methodology that does not factor in all the UI innovations (such as portals and other web-based technologies) that have taken place in the last years. Additionally, the FPA concept has not been closely integrated or used in any resource/project management tools and software.

### SUMMARY

The invention relates to estimating a size of developing a new user interface.

In a first general aspect, a method of estimating a size of developing a user interface for a predefined application development includes receiving a request for an estimated size of developing a user interface (UI) for a predefined application development. The method includes reading, in response to the request, weight points for the new UI from a UI taxonomy that is an abstraction of a class of UIs. The UI is to be an instance of the class. The method includes generating the estimated size using at least the weight points.

Implementations may include any or all of the following features. The method may further include also using at least one UI characteristic in generating the estimated size. The UI characteristic may indicate that information in the UI is to be transferred between different communication facilities. The UI characteristic may indicate that the UI requires configuration of a business solution. The UI characteristic may indicate that information in the UI is subject to a requirement for data retention. The UI characteristic may reflect time to be spent developing an application that uses the UI. The UI characteristic may indicate that the UI must be consistent with sophisticated functions. The UI characteristic may reflect documentation to be created for the UI. The UI characteristic may indicate that the UI must be susceptible to internationalization. The UI characteristic may indicate that the UI is subject to a performance requirement. The UI characteristic may indicate that the UI is subject to a security requirement. The UI characteristic may indicate that developing the UI involves third-party involvement. The UI characteristic may indicate that the UI is intended for several clients. The estimated size may constitute a time estimate generated using the weight points and a points-per-time measure. The method may further include monitoring the development of the UI and then updating the points-per-time measure based on the monitoring. An additional request regarding a modification of the UI may be received, and the method may further include generating a new estimated size in response to the additional request. The additional request may be received during the development of the UI. The weight points may be read from at least one of several aspects of the UI taxonomy to which the UI relates, the aspects including a UI layout, a UI principle, a UI environment and a UI style, each aspect being associated with at least one of the weight points. The method may further include initially assigning the weight points for at least an aspect of the UI taxonomy using a function-point analysis.

In a second general aspect, a computer system includes a UI taxonomy that is an abstraction of a class of UIs, wherein the system has received a request for an estimated size of developing a UI for a predefined application development, the UI to be an instance of the class. The system further includes a size estimating module that generates the estimated size using weight points for the UI read from the UI taxonomy.

Implementations may include any or all of the following features. The size estimating module may read the weight points from at least one aspect of the UI taxonomy to which the UI relates, the aspects including a UI layout, a UI principle, a UI environment and a UI style, each aspect being associated with at least one of the weight points. The estimated size may be a time estimate that the size estimating module generates using the weight points and a points-per-time measure, and the size estimating module may further monitor the development of the UI and then update the points-per-time measure based on the monitoring. Upon the system receiving an additional request regarding a modification of the UI, the size estimating module may generate a new estimated size in response to the additional request.

Advantages of the systems and techniques described herein may include any or all of the following: providing an improved estimation of an effort of creating a UI; providing an improved approach of taking UI features into account in estimations; providing that evaluations of work that has been performed can be used to update and improve the estimation components.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a system that estimates the size of developing a UI.

FIG. 2 schematically shows an enterprise system environment in which size estimation can be performed.

FIG. 3 shows an inside view of an exemplary UI engine that can be used in the FIG. 1 or 2 system.

FIG. 4 shows an example of an engine catalogue containing a UI taxonomy that can be used in size estimation.

FIG. 5 shows a flow chart of an exemplary method.

FIG. 6 is a block diagram of a general computer system.

Like reference numerals in the various drawings indicate like elements.

### DETAILED DESCRIPTION

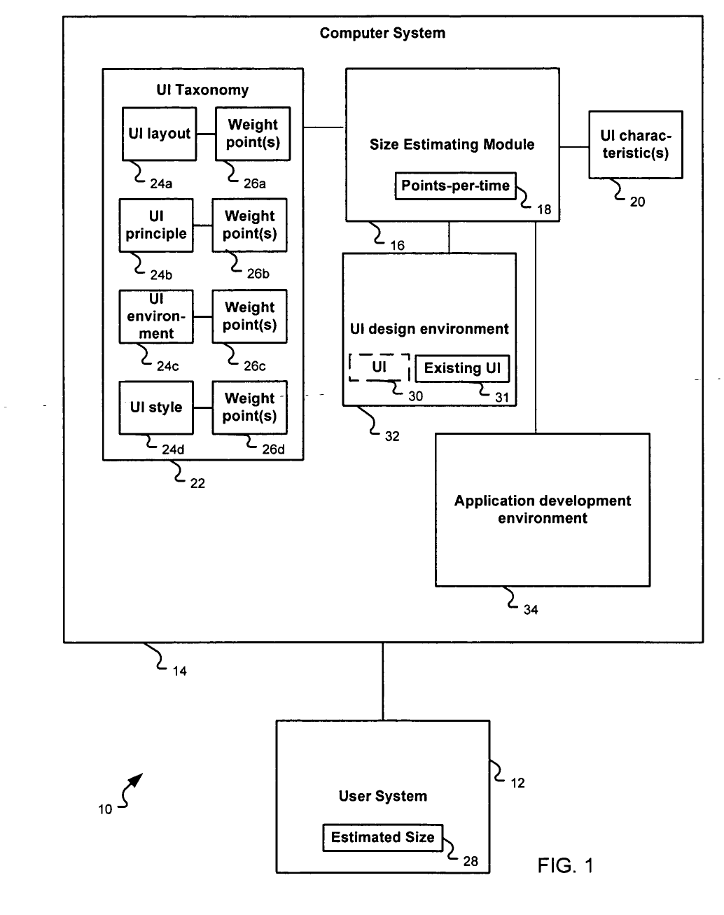

FIG. 1 shows a block diagram of a system 10 that can be used to estimate the size of developing a user interface (UI) for a predefined application development, such as when an existing application is to be modified or a new application is to be developed. The UI may be intended for use in the system 10 or in another system. Particularly, the system 10 generates an estimated size, such as a time estimate, using weight points.

The system 10 includes a user system 12 that can communicate with a computer system 14. For example, the user system is a personal computer that is connected to a server (the system 14) through a computer network. The user system may be used by persons that are involved in the planning or execution of developing UIs. As such, these persons include developers, system technicians, software designers, managers, project leaders and company representatives, to name a few examples. Any or all of these users can employ the user system in connection with planning or executing development of the UI. Particularly, they can obtain size estimates regarding the development of the UI.

The system 10 includes a size estimating module 16 that can receive input from the user system 12 and output one or more generated size estimates. The size estimating module can use one or more weight points in generating the estimate, combine the weight points with a points-per-time measure 18, or use one or more UI characteristics 20 in generating the size estimate, as will be described below.

The system 14 includes a UI taxonomy 22 that is used in the size estimation. The UI taxonomy is an abstraction of a class of UIs, and may for example include metadata that helps define the class. Particularly, the UI taxonomy may be a hierarchical classification of UI objects and their interrelationships such that it can be used in generating a new UI that is part of the defined class, and also to provide useful information for development efforts, such as those required to create the UI.

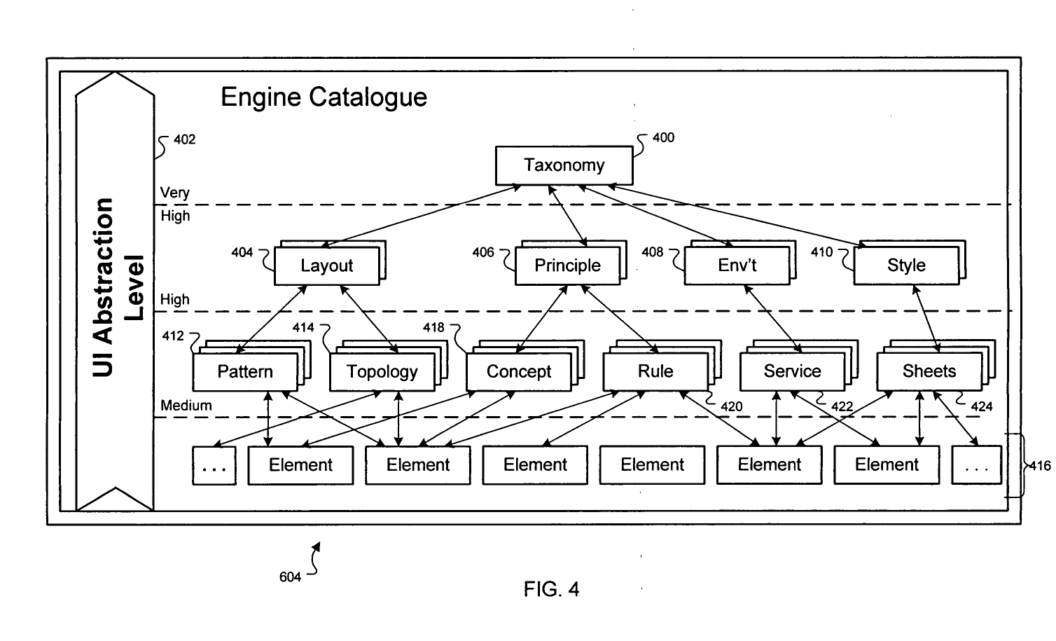

The information in the UI taxonomy may be organized in one or more aspects 24, of which some examples are shown: a UI layout 24a defines a layout that is to be used for the UI; a UI principle 24b defines a mandatory or guiding principle to be applied to the UI; a UI environment 24c describes an environment in which the UI is to be used; and a UI style 24d defines a style to be applied to the UI. As such, the UI taxonomy may be considered a hierarchical organization of information that is relevant to the class of UIs. In some implementations, the information in any or all of the aspects 24 may be organized in categories at a lower level as will be described below with reference to FIG. 4.

The UI taxonomy 22 includes one or more weight points 26. The weight points may be assigned to the aspects 24 (or to sub-categories thereof) to indicate (i.e., weight) the estimated impact of this aspect on the effort of creating the UI. Particularly, one or more weight points 26a may be associated with the UI layout 24a to indicate, in terms of points, how this particular UI layout affects the development work. As a simple example, a complex layout requires more points than a relatively simple layout. Similarly, the UI principle 24b may be associated with one or more weight points 26b indicating a relative weight that the applicable UI rules and guidelines place on the development effort; the UI environment 24c may be associated with one or more weight points 26c and the UI style 24d with one or more weight points 26d, respectively. The relative values of points assigned to different taxonomy features can affect the aggregation of points that is to become the basis for the estimation in different directions. For example, a high point value in the environment aspect can be counterweighed by a relatively low point value for UI principles.

The size estimating module 16 retrieves one or more of the weight points 24 from the UI taxonomy for use in the estimation. Upon performing the estimation, which may involve making a time estimate, the size estimation module may output an estimated size 28 to the user system 12. The estimated size 28 is the estimation for developing a UI 30 that does not currently exist. The development may involve creating the UI 30 from scratch, or by modifying an existing UI 31. The user(s) can interpret the estimated size 28, make changes in the plans for developing the UI 30, if necessary, and initiate or continue the development.

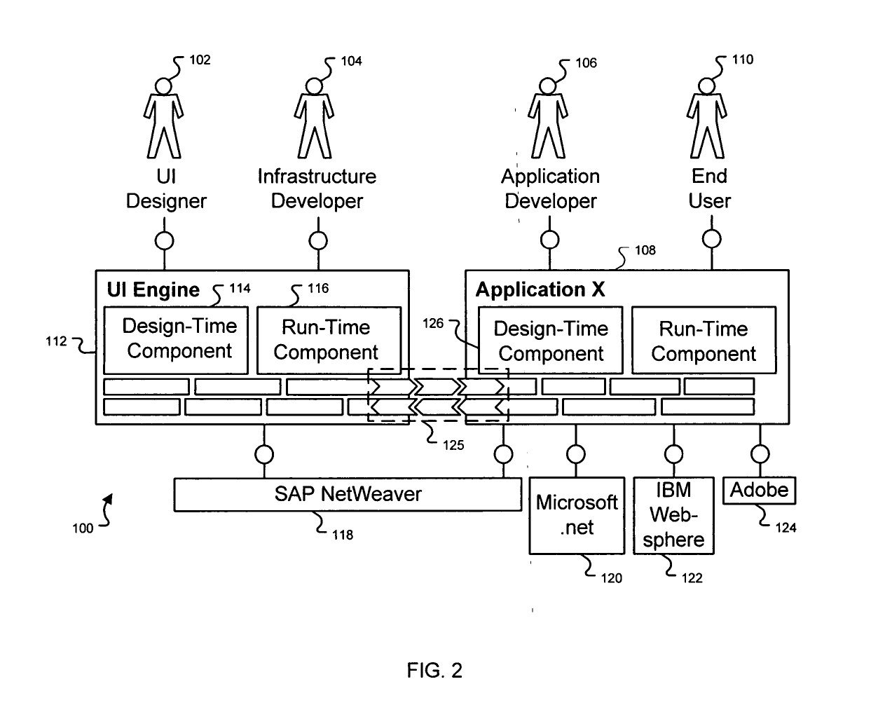

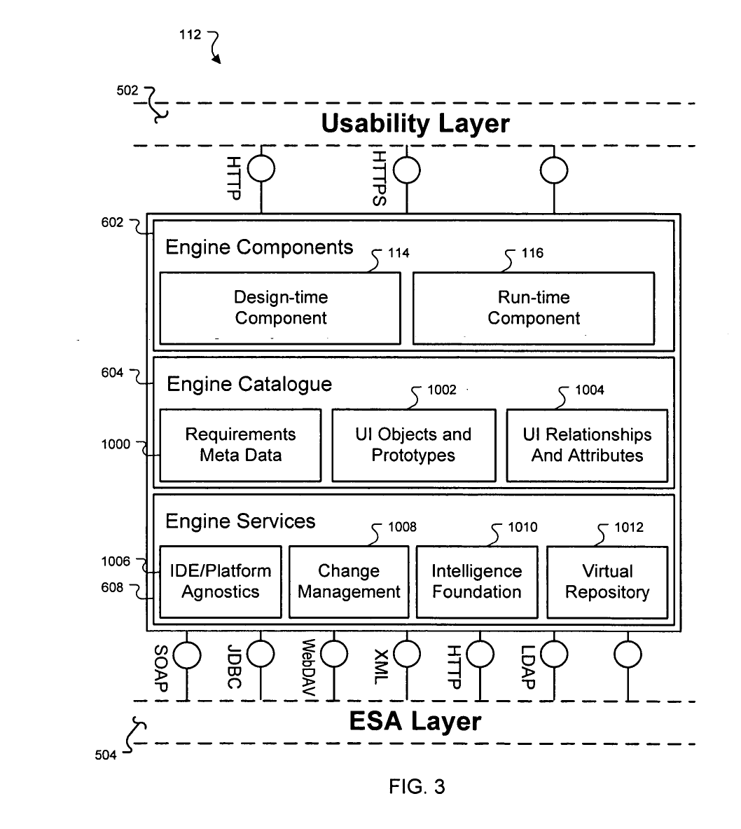

In some implementations, the UI is to be developed in the system 10. Particularly, the UI 30 may be planned for development in a UI design environment 32 in the system 10. The UI design environment may include a UI engine such as the one that will be described with reference to FIGS. 2 and 3. Moreover, the new, extended or revised software application for which the UI 30 is intended may be developed in an application development environment 34 that is here also included in the system 10. That is, the UI 30 may be developed for an application that currently does not exist and that is about to be developed, or for an existing application that is about to be extended, revised or otherwise modified. In each of these examples, the amount of application development work that is about to be done can be defined before performing the estimation of the size of developing the UI 30. In some situations, the size estimation module 16 can also take into account other aspects of the application development that is to be performed for the UI, as will be described below.

In short, relevant aspects of the UI taxonomy abstractly describe the UI development that is to be performed. The size estimation module 16 uses this information to provide a system-supported and automated feature for estimating the size of the project. Such a feature is an improvement to development environments, because it provides tools and framework for product managers and project leaders to better estimate the efforts needed to build new UIs. These users benefit from being able to estimate projects, manage change of scope, measure productivity, and communicate functional requirements. For example, they can accurately estimate efforts related to UI developments, benchmark against the history of other developments, and receive important key performance indicators for the productivity levels of platform-specific or project-specific developments. An example of the collaboration between some such users will now be described.

FIG. 2 schematically shows an enterprise system environment 100 in which an embodiment of the invention can be used. Particularly, the environment 100 supports estimation of an effort of developing a UI that is a member of a class of UIs, using weight points from a UI taxonomy that is an abstraction of the class. In this example, a prototype of the UI is first created for use by an application developer in creating the underlying software.

The people that are involved in the enterprise system environment 100 may include: at least one UI designer 102 who creates the UI prototype; at least one Infrastructure Developer 104 that creates the infrastructure; at least one application developer 106 that creates an application 108 that has the UI; and at least one end user 110 that uses the application 108. The environment 100 may reside on a single device or may be distributed over several devices.

Particularly, the environment 100 includes a UI engine 112 that the UI designer 102 and the infrastructure developer 104 can use. The UI engine manages the UI taxonomy 22 (shown in FIG. 1), and can handle the aspects 24 thereof. For example, the UI engine 112 can be used in assigning weight points to the aspects of the UI taxonomy and can interact with the size estimating module 16 for providing the estimated size 28. Once the points are assigned to respective taxonomy aspects, they are useful for generating one or more estimates. For example, estimates can be generated for different UIs by specifying different aspects (or sub-aspects) of the UI taxonomy.

The implementation of the UI engine constitutes a UI design environment in which designers or developers create and manage UI objects. For example, this may constitute the UI design environment 32 shown in FIG. 1. Particularly, the UI engine includes a design-time component 114 that the UI designer can access to create, change and publish UI objects, develop UI prototypes, build relationships between UI objects, and model UI event-loops, to name a few examples. The UI engine 112 also includes a run-time component 116 that the infrastructure developer 104 can consult to learn about various UI requirements and the rationale for creating particular UI objects. An infrastructure developer may also access the design-time component 112 when technical limitations or new infrastructure concepts are introduced. One example is when a new pattern—a predefined combination and arrangement of UI controls—is to be introduced.

The application 108 may be a so-called enterprise application that can be built and run under any of several platforms, such as a NetWeaver platform 118 available from SAP AG, or other platforms like Microsoft's .Net platform 120, IBM's WebSphere platform 122, or an Adobe platform 124. The application 108 is created in the application development environment 34 (See FIG. 1). This may include any integrated development environment (IDE), such as products available from SAP (NetWeaver Studio), Microsoft (Microsoft Visual Studio) or Adobe (Adobe Designer).

The application 108 includes a design-time component 126 with which the actual application implementation occurs: the UI is designed and configured using, or under guidance of, the UI prototype created by the UI designer. These and other operations benefit from the existence of a linking element 125 between the UI design environment and the application development environment. The linking element 125 may comprise an integration of the respective environments so that information and logic can be shared and mutually be taken into account in the respective environments. The linking element may provide that aspects of the UI design environment and aspects of the application development environment can be shared in the system 100 and taken into account in the size estimation. This may include an indication whether and to what extent third parties are to be involved in the UI development, or of the complexity of any application that is to be developed, to name two examples.

In short, services of the UI engine 112 are available to the application developer and the end user during development and use of the application 108. Particularly, application developers have access to UI objects integrated in the IDE. The end user, in turn, receives an application with a UI that is highly consistent and that has great usability. Moreover, the end user may access on-demand UI help, feedback and other features available directly through the UI engine 112.

FIG. 3 shows an exemplary architecture for the UI engine 112 made out of three parts: engine components 602, an engine catalogue 604 and engine services 608. The architecture of the UI engine 112 is shown between a usability layer 502 and an enterprise service architecture (ESA) layer 504. The usability layer 502 relates to anything that the user sees and actively works with. The ESA layer 504 relates to one or more services that are provided to users through the usability layer 502. The ESA layer (or a so-called service oriented architecture layer) may make at least one core application service (not shown) available as a standard-based, platform-independent web service, meaning that it can be accessed from the usability layer using web technology. Beneath the ESA layer 504 there may be a business layer (not shown) relating to the underlying models and software that handles the business data and that can perform a variety of operations. Particularly, the ESA services can use one or more of the operations in such a business layer.

The four roles of users (see FIG. 2) in the system can interact with any or all of the engine components 602 in a design environment. That is, they can interact with the design-time component 114 or with the run-time component 116. The design-time component 114 can be used in generating UI objects and for developing UI prototypes, for example. The run-time component 116 can provide information about UI requirements or UI objects.

The engine catalogue 604 here contains a requirements meta data portion 1000 that includes all the meta-data derived from the UI requirements. The engine catalogue 604 includes a UI objects and prototypes portion 1002. For example, this portion is generated with the design-time component 114 for the UI objects and UI prototypes. The catalogue also includes a UI relationships and attributes portion 1004 that includes relationships and attributes used by either or both of the design-time component 114 and the run-time component 116.

The engine services 608 are generic services used inside or outside the engine. For example, the engine services may be used in communicating UI rules and concepts to a development tool such as Adobe Designer. This allows the UI engine 112 to work with products of other software vendors to support the development of UIs on third-party platforms. The engine services 608 includes an IDE/platform agnostics portion 1006 that allows the engine 112 to interact with different IDEs or with different platforms. For example, the portion 1006 may provide that the engine 112 interacts with different GUI builders, editors and compilers, to name just a few examples. A change management portion 1008 may manage changes in the UI engine 112. For example, the changes may relate to the UI objects or the UI prototypes.

The engine services 608 includes an intelligence foundation 1010 that may be a technical component built to provide adaptive UI personalization, manage end-user performance metrics, and maintain UI history. In some implementations, the intelligence foundation 1010 provides or interacts with a UI agent software providing a context-aware, affinity-enabled UI that anticipates user needs and assists with goals. The engine services 608 further includes a virtual repository 1012 that allows access to third party UI metadata. This may provide that third-party UI content can be assembled, virtually visualized and adapted, to name a few examples.

FIG. 4 shows an example of the engine catalogue 604 that can be used in the engine 112 or in the system 10. The engine catalogue 604 includes a taxonomy 400 that is a classification scheme of information components (for example, terms, concepts, graphics, sounds, etc.) and their interrelationships. For example, the UI taxonomy 22 (see FIG. 1) can include the taxonomy 400. The taxonomy 400 is a hierarchical classification of UI objects and their interrelationships that supports the user in identifying the UI of an application and its features. Here, the taxonomy 400 is hierarchically arranged according to an abstraction level 402 that ranges from very high to low. The taxonomy 400 represents a very high abstraction level of UI objects and it groups together possible Layouts, Principles, Environments and Styles allowed in a UI.

The UI taxonomy 400 can help UI designers and infrastructure developers by providing a placeholder for the metadata arriving from usability or technical UI requirements and standards. Furthermore, the taxonomy 400 can improve consistency and support innovations by application developers while implementing the UI. The UI taxonomy 400 can also provide on-demand help for end-users who have problems understanding the navigation, content or functions of an application. And, weight points can be assigned to the taxonomy and be taken into account in size estimations.

At the high level of UI abstraction, the taxonomy 400 includes one or more of: a UI layout 404, a UI principle 406, a UI environment 408 and a UI style 410. The UI layout 24a (see FIG. 1) is an example of the UI layout 404; the principle 24b is an example of the UI principle 406, the UI environment 24c an example of the UI environment 408 and the UI style 24d an example of the UI style 410, respectively. Each of the UI layout, the UI principle, the UI environment and the UI style can characterize the UI taxonomy and contribute to a definition of a UI class that can be created with the taxonomy. When at least a UI layout and a UI principle are included, the UI taxonomy is an abstraction of a class of UIs that are consistent with the UI layout and the UI principle.

Each layout 404 can include one or more UI patterns 412 and one or more UI topologies 414. The UI patterns and UI topologies are at a medium level of UI abstraction. A UI pattern is an archetype used to perform a task common to a number of applications. A UI topology represents the layout navigation, capturing the possible event-loop of screens/steps/clicks that can be used. Each UI pattern and UI topology can involve one or more UI elements 416, which are situated at a low level of UI abstraction in the taxonomy 400. The UI elements 416 are a low abstraction level of UI objects that are representative of the basic controls available in a UI.

At the low abstraction level, the UI principle 406 can have one or more UI concepts 418 and one or more UI rules 420. An example of the UI concept 418 is a non-mandatory guideline available for the UI. An example of the UI rule 420 is a mandatory rule that must be followed in the UI. Each UI concept and UI rule can apply to one or more of the UI elements 416.

The UI environment 408 may relate to a specific portal environment where the UI is to be implemented and can include one or more UI services 422 at the medium level of UI abstraction. The UI service is a platform function that makes up part of the run-time environment where taxonomies can work properly. Each UI service can involve one or more of the UI elements 416.

The UI style 410 can include one or more UI sheets 424 at the medium level of UI abstraction. Sheets are the color/fonts/generic features for the delivered UI. Each UI sheet applies to one or more of the UI elements 416.

The UI taxonomy 400 is distilled from the standards and requirements of the usability, business and technical layers of enterprise software as an abstract representation of a class of UIs that are consistent therewith. UI taxonomies can create order in the unstructured world of UI design. UI taxonomies can facilitate a decoupling of front-end design from front-end logic and provide transparency and accountability between the tasks of UI designers and developers. UI taxonomies can also provide automated functions to account for and communicate guidelines to all development participants.

More than one UI taxonomy can be referenced in a software application program. In products from SAP AG, separate UI taxonomies may be implemented for Self-Services, Accessibility, Reporting, Mobile, and other applications. Priorities can be applied, for example by weighting the objects of UI taxonomies. For example, the UI taxonomy for Accessibility may be given the highest priority in any standard enterprise application, and its UI rules and concepts may then take precedence over others.

With reference again to FIG. 1, the estimated size 28 is generated using any or all of the weight points 26 from the UI taxonomy. The estimated size depends both on how extensive the deliverable—i.e., the UI—is, and on how much of the deliverable can be produced within a defined period of time.

Initially, the application development is defined. That is, the scope of development for creating the new application, or modifying an existing one, as the case may be, is determined. Using this knowledge, the required effort in developing the UI for this predefined application development can be derived from the total weight points of the UI taxonomy. Each UI object of the UI taxonomy—whether a concept, rule, topology, element etc.—has certain weight point(s) assigned to it. The weight points can be assigned in analogy with how function points are determined in function point analysis. By combining the applicable function points, an estimate of the extent of the UI is obtained.

Conceptually, weight points can be viewed as the “currency” for estimating the effort of UI development. For example, if a customer decides to build a new performance management application UI for its top performers, then the weight points from all the affected UI objects (e.g. the UI rule and UI elements used) can be summed up and adjusted by the affected UI characteristics (e.g. high security and identity management is essential for a performance management application). In this case, the total weight points may be 100. Then the weight points are translated into hours or total full-time employees required. To start with, it could be that the customer of such system calibrates 1 weight point to be 1 hour of a person's work. Then the development of the UI for the performance management application will require 100 hours of the person's work. Over time, the system can adjust the weight point(s) to the actual average determined using people's reported history of their efforts on the respective UI objects and characteristics. It could be that 1 weight point after a year is equivalent to 0.75 hour of the person's work or worse (depending on the maturity of the technology, skill set of the people, etc.)

Upon receiving such a result of total weight points the system can ask the user whether the required work can be parallelized (i.e. can two or more people work on different tasks of the project and close the project in shorter time than what 1 person can do). The system could take business parameters into account, for example that the application needs to be finished in 3 months using a certain number of people, and the system can provide feedback based on the weight points how many people may be required and what parts can be parallelized or not.

Additionally, the UI characteristic(s) 20 can be used in the size determination. The UI characteristic may be one that relates to the UI30, the underlying application for the UI, or other aspects. Some exemplary such UI characteristics are described below. In some implementations, the characteristics can be derived from the SAP Product Standards and aligned with the so-called Value Adjustment Factor of function point analysis. The UI characteristic may be applied as a weighting factor to the weight point(s), to name one example.

A UI characteristic may relate to application integration and interfaces. For example, the UI characteristic can indicate how many communication facilities are to aid in the transfer or exchange of information with the application or system. This may correlate to “data communications” and “distributed data processing” in the function point analysis. Thus, the UI characteristic can indicate that information in the UI is to be transferred between different communication facilities.

A UI characteristic may relate to configuration of a business solution. For example, the UI characteristic can indicate whether and to what extent the application requires business solution configuration, such as to implement and upgrade an existing solution at a customer's site, or to define and parameterize the technical and business process flow at a customer's site. This may correlate to “facilitate change” in the function point analysis. Thus, the UI characteristic can indicate that the UI requires configuration of a business solution.

A UI characteristic may relate to data archiving. For example, the UI characteristic can indicate whether and to what extent the development requires the solution to take into account the retention of data needs (e.g. legal or country-specific regulations that may exist and dictate such). Thus, the UI characteristic can indicate that information in the UI is subject to a requirement for data retention.

A UI characteristic may relate to the development environment. For example, the UI characteristic can indicate whether and to what extent time is to be spent on the available development environment(s) to develop and ship applications and solutions. Thus, the UI characteristic can reflect time to be spent developing an application that uses the UI.

A UI characteristic may relate to functional correctness. For example, the UI characteristic can indicate whether and to what extent the application includes extensive logical or mathematical processing or needs to be developed with any particular consideration to reusability. This may correlate to “complex processing” or “reusability” in the function point analysis. Thus, the UI characteristic can indicate that the UI must be consistent with sophisticated functions.

A UI characteristic may relate to documentation. For example, the UI characteristic can indicate the effort to provide product documentation to enable customers to install, implement and use the software. Thus, the UI characteristic can reflect documentation to be created for the UI.

A UI characteristic may relate to globalization. For example, the UI characteristic can indicate whether and to what extent the solution needs to be internationalized, such as to provide multi-language support, code page handling, Unicode enabling, double byte support, time zones support, currency handling, or calendar support. Thus, the UI characteristic can indicate that the UI must be susceptible to internationalization.

A UI characteristic may relate to performance and scalability. For example, the UI characteristic can indicate whether and to what extent the buyer or user has required a specific response time or throughput, or whether there are scalability requirements that need to be considered in the development. This may correlate to “performance,” “transaction rate,” “on-line data entry,” or “on-line update” in the function point analysis. Thus, the UI characteristic can indicate that the UI is subject to a performance requirement.

A UI characteristic may relate to security. For example, the UI characteristic can indicate whether and to what extent there are any additional security requirements that will take time for the development of the UI. Thus, the UI characteristic can indicate that the UI is subject to a security requirement.

A UI characteristic may relate to third-party involvement. For example, the UI characteristic can indicate whether and to what extent there will be third-party involvement and whether it will take a significant toll on the time to develop the UI. Thus, the UI characteristic can indicate that developing the UI involves third-party involvement.

A UI characteristic may relate to multiple clients. For example, the UI characteristic can indicate whether and to what extent the application is (or is intended to be) specifically designed, developed, and supported to be installed at multiple instances. This may correlate to “multiple sites” in the function point analysis. Thus, the UI characteristic can indicate that the UI is intended for several clients.

The estimated size 28 also depends on how long it takes to perform the work corresponding to a weight point. This delivery rate can be calculated based on past project performance or by peer group benchmarks (similar developments). The delivery rate is expressed in weight points per hour (WP/Hr) and can be applied to similar proposed projects to estimate effort (i.e. Project Hours=estimated project weight points WP/Hr).

The system 10 can be used for productivity measurement. If the UI taxonomy 22 is technology/platform independent, the weight points can be used as a vehicle to compare productivity across dissimilar tools and platforms. More importantly, they can be used to establish a productivity rate (i.e. WP/Hr) for a specific tool set and platform. Once productivity rates are established they can be used for project estimating as described above and tracked over time to determine the impact continuous process improvement initiatives have on productivity.

Managing scope change for ongoing projects is another key benefit of implementations described herein. Once a project has been approved and the weight point count has been established, it becomes a relatively easy task to identify, track and communicate new and changing requirements. As requests come in from users for new UI or capabilities, weight point counts can be developed and applied against the rate. This result is then used to determine the impact on budget and effort. The user and the project team can then determine the importance of the request against its impact on budget and schedule. At the conclusion of the project the final weight point count can be evaluated against the initial estimate to determine the effectiveness of requirements gathering techniques. This analysis helps to identify opportunities to improve the requirements definition process.

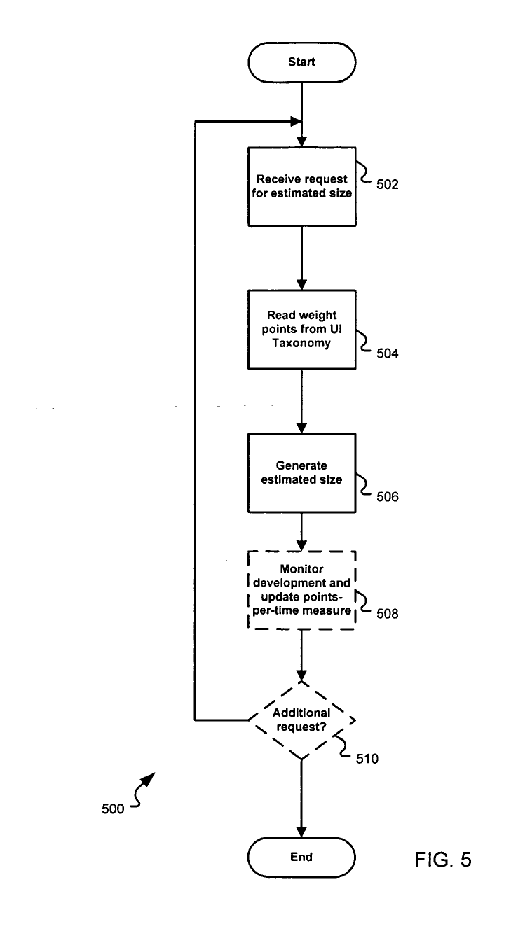

FIG. 5 shows a flow chart of an exemplary method 500 of estimating a size of developing a UI for a predefined application development. The method 500 can be performed using a computer program product, that is, by a processor executing instructions stored in a computer readable medium.

The method 500 comprises receiving, in step 502, a request for an estimated size of developing a UI for a predefined application development. For example, a user of the user system 12 can transmit a request to the system 14 for the estimated size 28 relating to developing the UI 30. The UI 30 can be planned for development from scratch, or for development using the existing UI 31, to name two examples.

In step 504, the method 500 comprises reading, in response to the request, weight points for the UI from a UI taxonomy that is an abstraction of a class of UIs. The UI is to be an instance of the class. For example, the size estimating module 16 reads one or more of the weight points 26 from the UI taxonomy 22. The UI taxonomy 22 may be accessible through the UI engine 112.

In step 506, the method 500 comprises generating the estimated size using at least the weight points. For example, the size estimating module 16 aggregates the obtained weight points 26 with applicable weight factors depending on UI characteristics, and then generates the estimated size 28 by combining the weighted points with the points-per-time measure 18.

In optional step 508, the method 500 comprises monitoring the development of the UI and then updating a points-per-time measure based on the monitoring. For example, the size estimating module 16 can monitor development work in the UI design environment 32 or the application development environment 34, or both, and then update the points-per-time measure based on the work progress.

In optional step 510, the method 500 determines whether there is an additional request. If so, steps 502-506 (and optionally step 508) are repeated. The additional request is received upon returning to step 502 and may relate to a modification of the UI. Such a request may be initiated because a user is about to decide whether the modification should be done or whether it is not feasible. A new estimated size can be generated in response to the additional request. The additional request can be received before, during or after the development of the UI.

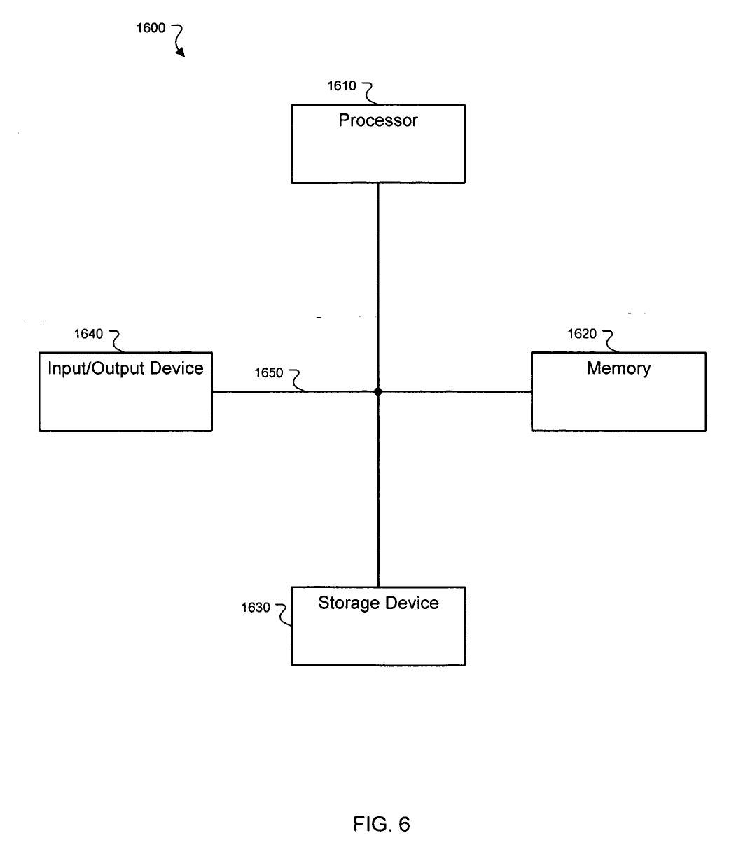

FIG. 6 is a block diagram of a computer system 1600 that can be used in the operations described above, for example in the system 10. The system 1600 includes a processor 1610, a memory 1620, a storage device 1630 and an input/output device 1640. Each of the components 1610, 1620, 1630 and 1640 are interconnected using a system bus 1650. The processor 1610 is capable of processing instructions for execution within the system 1600. In one embodiment, the processor 1610 is a single-threaded processor. In another embodiment, the processor 1610 is a multi-threaded processor. The processor 1610 is capable of processing instructions stored in the memory 1620 or on the storage device 1630 to display graphical information for a user interface on the input/output device 1640.

The memory 1620 stores information within the system 1600. In one embodiment, the memory 1620 is a computer-readable medium. In one embodiment, the memory 1620 is a volatile memory unit. In another embodiment, the memory 1620 is a non-volatile memory unit.

The storage device 1630 is capable of providing mass storage for the system 1600. In one embodiment, the storage device 1630 is a computer-readable medium. In various different embodiments, the storage device 1630 may be a floppy disk device, a hard disk device, an optical disk device, or a tape device.

The input/output device 1640 provides input/output operations for the system 1600. In one embodiment, the input/output device 1640 includes a keyboard and/or pointing device. In one embodiment, the input/output device 1640 includes a display unit for displaying graphical user interfaces. For example, the input/output device can generate any or all GUIs described herein.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of estimating a size of developing a user interface for a predefined application development, the method comprising:
receiving a request for an estimated size of developing a user interface (UI) for a predefined application development;
reading, in response to the request, weight points for the UI from a UI taxonomy that is an abstraction of a class of UIs, wherein the UI is to be an instance of the class; and
generating the estimated size using at least the weight points.

2. The method of claim 1, further comprising also using at least one UI characteristic in generating the estimated size.

3. The method of claim 2, wherein the UI characteristic indicates that information in the UI is to be transferred between different communication facilities.

4. The method of claim 2, wherein the UI characteristic indicates that the UI requires configuration of a business solution.

5. The method of claim 2, wherein the UI characteristic indicates that information in the UI is subject to a requirement for data retention.

6. The method of claim 2, wherein the UI characteristic reflects time to be spent developing an application that uses the UI.

7. The method of claim 2, wherein the UI characteristic indicates that the UI must be consistent with sophisticated functions.

8. The method of claim 2, wherein the UI characteristic reflects documentation to be created for the UI.

9. The method of claim 2, wherein the UI characteristic indicates that the UI must be susceptible to internationalization.

10. The method of claim 2, wherein the UI characteristic indicates that the UI is subject to a performance requirement.

11. The method of claim 2, wherein the UI characteristic indicates that the UI is subject to a security requirement.

12. The method of claim 2, wherein the UI characteristic indicates that developing the UI involves third-party involvement.

13. The method of claim 2, wherein the UI characteristic indicates that the UI is intended for several clients.

14. The method of claim 1, wherein the estimated size comprises a time estimate generated using the weight points and a points-per-time measure.

15. The method of claim 14, further comprising monitoring the development of the UI and then updating the points-per-time measure based on the monitoring.

16. The method of claim 1, wherein an additional request regarding a modification of the UI is received, further comprising generating a new estimated size in response to the additional request.

17. The method of claim 16, wherein the additional request is received during the development of the UI.

18. The method of claim 1, wherein the weight points are read from at least one of several aspects of the UI taxonomy to which the UI relates, the aspects including a UI layout, a UI principle, a UI environment and a UI style, each aspect being associated with at least one of the weight points.

19. The method of claim 1, further comprising initially assigning the weight points for at least an aspect of the UI taxonomy using a function-point analysis.

20. A computer program product tangibly embodied in an information carrier, the computer program product including instructions that, when executed, cause a processor to perform operations comprising:
receiving a request for an estimated size of developing a user interface (UI) for a predefined application development;
reading, in response to the request, weight points for the UI from a UI taxonomy that is an abstraction of a class of UIs, wherein the UI is to be an instance of the class; and
generating the estimated size using the weight points.

21. A computer system comprising:
a user interface (UI) taxonomy that is an abstraction of a class of UIs, wherein the computer system has received a request for an estimated size of developing a UI for a predefined application development, the UI to be an instance of the class; and
a size estimating module that generates the estimated size using weight points for the UI read from the UI taxonomy.

22. The computer system of claim 21, wherein the size estimating module reads the weight points from at least one aspect of the UI taxonomy to which the UI relates, the aspects including a UI layout, a UI principle, a UI environment and a UI style, each aspect being associated with at least one of the weight points.

23. The computer system of claim 21, wherein the estimated size is a time estimate that the size estimating module generates using the weight points and a points-per-time measure, and wherein the size estimating module further monitors the development of the UI and then updates the points-per-time measure based on the monitoring.

24. The computer system of claim 21, wherein upon the system receiving an additional request regarding a modification of the UI, the size estimating module generates a new estimated size in response to the additional request.
